(19) United States
(12) Patent Application Publication
(10) Pub. No.: US 2004/0154609 A1
(43) Pub. Date: Aug. 12, 2004

(54) Cooking apparatus

(75) Inventors: Dae-Sung Han, Hwasung-City (KR); Chul Kim, Yongin-City (KR); Yong-Woon Han, Kunpo-City (KR); Seong-Deog Jang, Suwon-City (KR); Kyung-Hee Ham, Seoul (KR); Joo-Yeong Yeo, Hwasung-City (KR); Han-Seong Kang, Suwon-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., LTD., Suwon-city (KR)

(21) Appl. No.: 10/713,159

(22) Filed: Nov. 17, 2003

(30) Foreign Application Priority Data
Feb. 6, 2003 (KR) 2003-7557

(51) Int. Cl. A47J 37/00; F24C 3/00

(52) U.S. Cl. 126/41 R; 126/39 R

(57) ABSTRACT

A cooking apparatus capable of effectively utilizing thermal energy of a heating unit to heat food includes a cabinet opened at a top surface thereof to provide an opening over which food to be cooked is laid. A grill unit is seated in the opening of the cabinet so as to support the food over the opening. A heating unit is provided in the cabinet so that a front surface thereof faces the grill unit to radiate thermal energy to the grill unit. A plurality of reflecting members are provided at predetermined positions around a rear surface of the heating unit, and are installed to be spaced apart from each other by a predetermined gap to provide an air layer between the reflecting members. The construction of the cooking apparatus allows far infrared rays radiated from a rear surface of the heating unit to be reflected to a front of the heating unit, in addition to preventing heat from being transmitted from the heating unit to a rear portion of the heating unit due to an air layer provided between the reflecting members. Accordingly, most of the thermal energy generated from the heating unit may be used for cooking the food.

### CROSS-REFERENCE TO RELATED APPLICATIONS

This application claims the priority of Korean Patent Application No. 2003-7557, filed Feb. 6, 2003 in the Korean Intellectual Property Office, the disclosure of which is incorporated herein by reference.

### BACKGROUND OF THE INVENTION

1. Field of the Invention

The present invention relates, in general, to cooking apparatuses and, more particularly, to a cooking apparatus which is capable of effectively utilizing heat generated to heat and cook food.

2. Description of the Related Art

As is well known to those skilled in the art, cooking apparatuses are appliances which heat and cook food using heat generated by heating units.

Of these cooking apparatuses, there is a cooking apparatus which directly transmits heat to food, such as meat or sausage, to cook the food. The cooking apparatus is provided with a heating unit and a grill unit. The heating unit directly transmits heat to the food. The grill unit is mounted at a predetermined position above the heating unit to support the food so as to be spaced apart from the heating unit.

When heat is generated by the heating unit, thermal energy, such as heat and far infrared rays, is generated. The food laid on the grill unit is heated and cooked by the thermal energy radiated from a front surface of the heating unit.

However, the cooking apparatus equipped with the grill unit has a problem in that heat is directly transmitted from the heating unit to the grill unit, so that the part of food in contact with the grill unit is undesirably burnt, thus deteriorating the taste of the food and negatively affecting people's health.

### SUMMARY OF THE INVENTION

Accordingly, it is an aspect of the present invention to provide a cooking apparatus which is designed to effectively utilize thermal energy generated by a heating unit to cook food.

Additional aspects and advantages of the invention will be set forth in part in the description which follows and, in part, will be obvious from the description, or may be learned by practice of the invention.

The foregoing and/or other aspects of the present invention are achieved by providing a cooking apparatus including a cabinet, a grill unit, a heating unit, and a plurality of reflecting members. The cabinet is opened at a top surface thereof to provide an opening over which food to be cooked is laid. The grill unit is seated in the opening of the cabinet so as to support the food over the opening. The heating unit is provided in the cabinet so that a front surface thereof faces the grill unit to radiate thermal energy to the grill unit. The plurality of reflecting members are provided at predetermined positions around a rear surface of the heating unit, and are installed to be spaced apart from each other by a predetermined gap to provide an air layer between the reflecting members.

According to an aspect of the invention, at least one of the reflecting members is provided at a predetermined portion thereof with a projection, with an end of the projection being supported by a neighboring reflecting member so that the reflecting members are spaced apart from each other by the predetermined gap.

According to an aspect of the invention, the reflecting members surround upper, lower, and rear portions of the heating unit, thus guiding the thermal energy generated from the heating unit to a front of the heating unit.

### BRIEF DESCRIPTION OF THE DRAWINGS

The above and/or other aspects and advantages of the invention will become apparent and more readily appreciated from the following description of the preferred embodiment, taken in conjunction with the accompanying drawings of which:

FIG. 1 is an exploded perspective view of a cooking apparatus, according to an embodiment of the present invention;

FIG. 2 is a sectional view of the cooking apparatus of FIG. 1; and

FIG. 3 is an enlarged view of a part of the cooking apparatus of FIG. 2.

### DETAILED DESCRIPTION OF THE PREFERRED EMBODIMENTS

Reference will now be made in detail to the present preferred embodiment of the present invention, examples of which are illustrated in the accompanying drawings, wherein like reference numerals refer to like elements throughout.

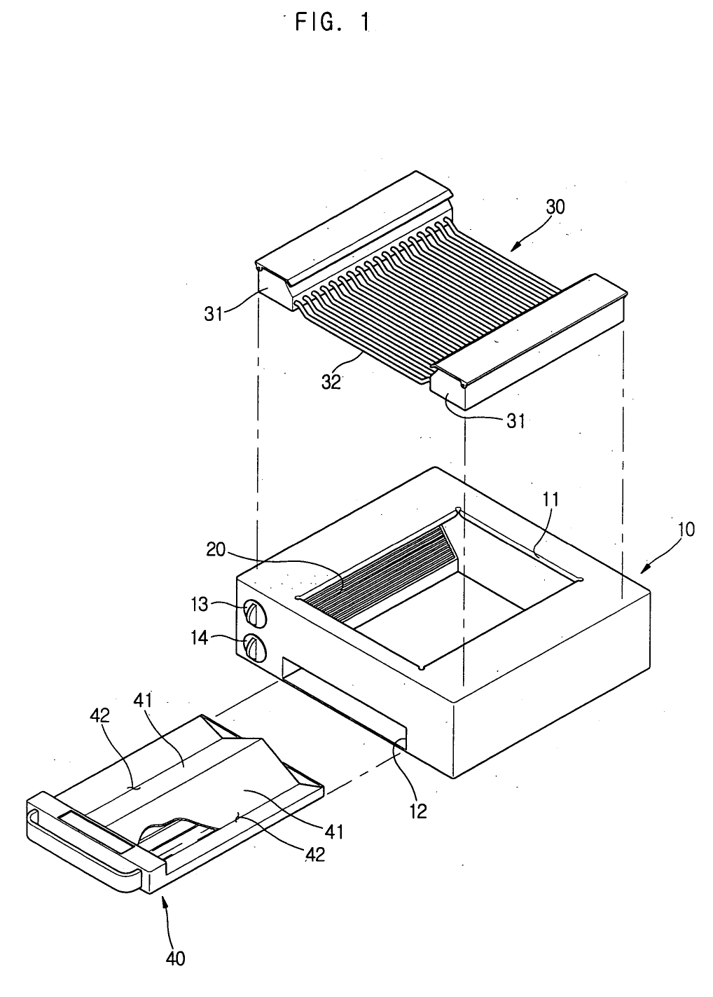

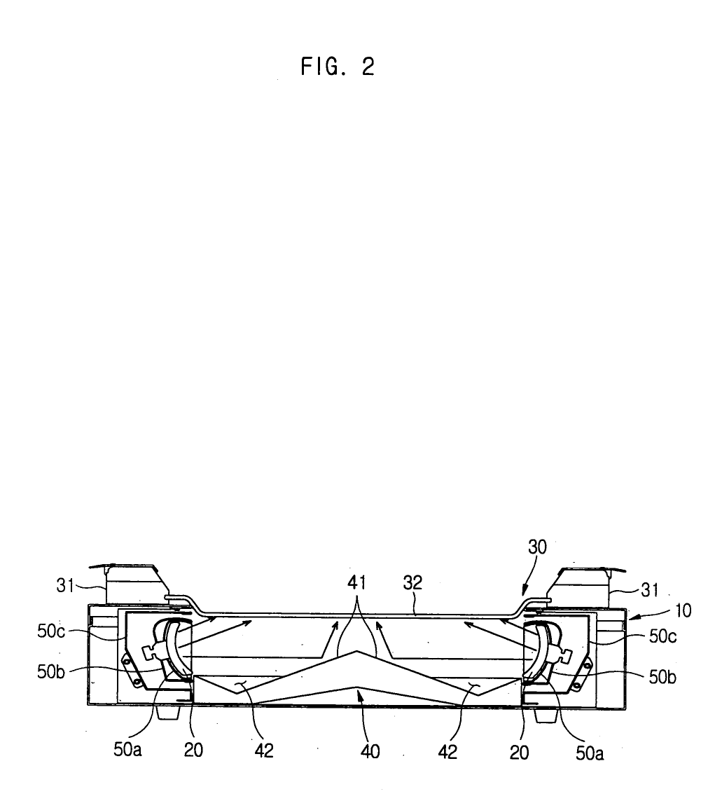

As illustrated in FIGS. 1 and 2, a cooking apparatus according to the present invention includes a box-shaped cabinet 10. A plurality of heating units 20 are installed in the cabinet 10 to transmit heat to food to be cooked. A grill unit 30 on which the food is laid is seated on a top surface of the cabinet 10. The cooking apparatus also has a tray 40. The tray 40 collects materials dropping from the food laid on the grill unit 30, such as oil, and guides thermal energy from the heating units 20 to the grill unit 30.

The cabinet 10 is opened at the top surface thereof to provide an opening 11 and the grill unit 30 is seated in the opening 11, so that heat generated by the heating units 20 is transmitted to the grill unit 30. The cabinet 10 is opened at a front surface thereof so that the tray 40 is removably moved in and out the cabinet 10 through the opening, to be received in a cavity 12 provided in an interior of the cabinet 10. A timer switch 13 to control operation time of the heating units 20, and a power switch 14 to control heating temperature are provided at a surface of the cabinet 10.

The heating units 20 each include a ceramic member with a heating element to generate thermal energy, such as heat and far infrared rays. The heating units 20 are set in both sides of the cavity 12 so that front surfaces of the heating units 20 are opposite to each other. Further, the heating units 20 are inclinedly arranged to tilt toward the opening 11 to transmit the thermal energy to the grill unit 30 which is seated in the opening 11.

The grill unit 30 includes two water tanks 31, and a plurality of grill pipes 32. The water tanks 31 are seated on both sides of the top surface of the cabinet 10, and contain water therein. The grill pipes 32 are arranged between the two water tanks 31 to connect the two water tanks 31 to each other, and have hollow structures so that water flows therein. Thus, the grill pipes 32 are continuously cooled by water supplied by the water tanks 31, thus preventing food in contact with the grill pipes 32 from being burnt.

The tray 40 is formed with a hump along a central axis thereof, and provided with reflecting plates 41 at both sides of the hump, thus reflecting the heat or far infrared rays from the heating units 20 to the grill unit 30. An oil collecting groove 42 is provided along a lowermost edge of each reflecting plate 41 to collect oil dropping from the food which is laid on the grill unit 30. Further, although not shown in the drawings, a predetermined amount of water is contained in the tray 40 so as to prevent an excessive rise in the temperature of the oil collecting grooves 42 and the reflecting plates 41, thus preventing oil collected in the oil collecting grooves 42 from being burnt and adhered to the tray 40.

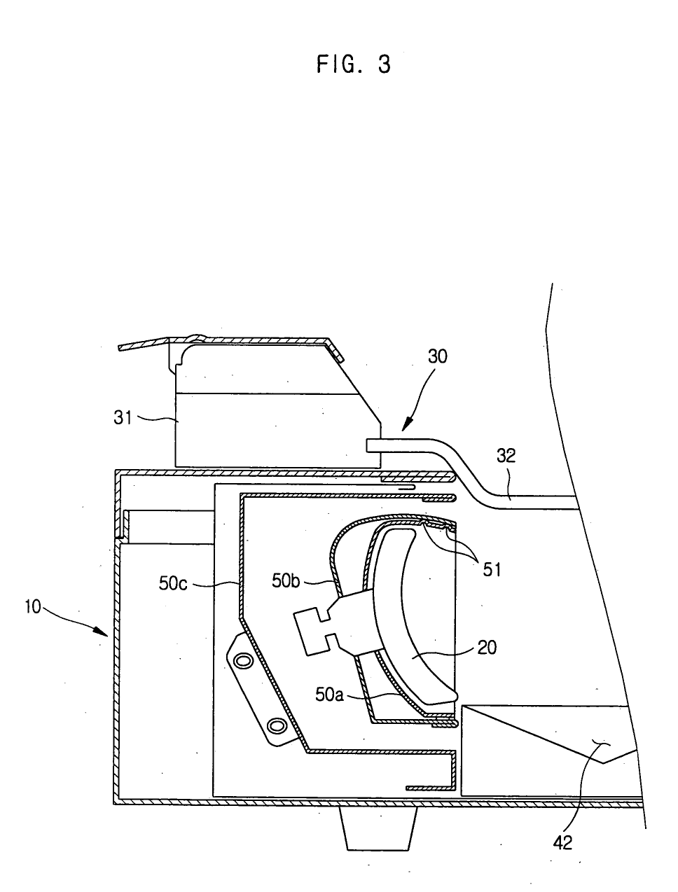

As illustrated in FIG. 3, the cooking apparatus according to the present invention also includes reflecting members 50a, 50b, and 50c. The reflecting members 50a, 50b, and 50c guide thermal energy from a rear surface of each heating unit 20 to the opening 11 over which the food to be cooked is laid.

The reflecting members 50a, 50b, and 50c surround upper, lower, and rear portions of each heating unit 20, and are spaced apart from each other by a predetermined distance to provide an air layer between the reflecting members 50a, 50b, and 50c. According to the embodiment of the present invention, the cooking apparatus is provided with the three reflecting members 50a, 50b, and 50c to surround the upper, lower, and rear portions of each heating unit 20. For convenience of description, the reflecting members 50a, 50b, and 50c will be hereinafter referred to as first, second, and third reflecting members, respectively.

The far infrared rays generated by each heating unit 20 are repeatedly reflected by the three reflecting members 50a, 50b, and 50c to be guided to the front of the heating unit 20. The heat generated by each heating unit 20 is thus limitedly transmitted to a rear portion of the heating unit 20 due to a heat insulating effect of the air layer provided between the three reflecting members 50a, 50b, and 50c, so most of the thermal energy generated from each heating unit 20 is transmitted to the front of the heating unit 20 and is used to cook food.

Further, according to the embodiment of the present invention, a plurality of projections 51 are provided at a predetermined portion of the first reflecting member 50a so that the first reflecting member 50a is spaced apart from the second reflecting member 50b by the predetermined gap. The projections 51 are projected toward the second reflecting member 50b so that an end of each projection 51 is supported by the second reflecting member 50b, thus keeping the first reflecting member 50a spaced apart from the second reflecting member 50b.

An operation and operational effect of the cooking apparatus according to the present invention will be described below.

When power is applied to the cooking apparatus after laying food on the grill unit 30, heat and far infrared rays are generated from the heating units 20 provided at both sides of the cabinet 10 so as to heat and cook the food. In this case, water serving as a coolant is contained in the oil collecting grooves 42, thus preventing temperature of the oil collecting grooves 42 from exceeding a predetermined value.

At this time, thermal energy, such as the heat and far infrared rays, is radiated from the rear surface of each heating unit 20. In this case, the heat is limitedly transmitted to the rear portion of each heating unit 20 due to the heat insulating effect of the air layer formed between the reflecting members 50a, 50b, and 50c. Meanwhile, the far infrared rays are reflected by the reflecting members 50a, 50b, and 50c to be guided to the front of each heating unit 20. Thus, most of the thermal energy radiated from the rear surface of each heating unit 20 is transmitted to the front of the heating unit 20, thus being used for cooking the food.

As is apparent from the above description, the present invention provides a cooking apparatus which is provided with a plurality of reflecting members, thus reflecting far infrared rays radiated from a rear surface of a heating unit designed so that a front surface thereof faces food to be cooked. The reflecting members prevent heat generated from the heating unit from being transmitted to the rear portion of the heating unit due to an air layer provided between the reflecting members. Therefore, most of thermal energy generated from the heating unit may be used to cook the food.

Although an embodiment of the present invention have been shown and described, it would be appreciated by those skilled in the art that changes may be made in the embodiment without departing from the principles and spirit of the invention, the scope of which is defined in the claims and their equivalents.

What is claimed is:

1. A cooking apparatus, comprising:
a cabinet opened at a top surface thereof to provide an opening over which food to be cooked is laid;
a grill unit seated in the opening of the cabinet so as to support the food over the opening;
a heating unit provided in the cabinet so that a front surface thereof faces the grill unit to radiate thermal energy to the grill unit; and
a plurality of reflecting members provided at predetermined positions around a rear surface of the heating unit, the reflecting members installed to be spaced apart from each other by a predetermined gap to provide an air layer between the reflecting members.

2. The cooking apparatus according to claim 1, wherein at least one of the reflecting members comprises:
a projection provided at a predetermined portion of the at least one reflecting member, and having an end supported by a neighboring reflecting member so that the at least one reflecting member and the neighboring reflecting member are spaced apart from each other by the predetermined gap.

3. The cooking apparatus according to claim 1, wherein the plurality of reflecting members surround upper, lower, and rear portions of the heating unit, guiding the thermal energy generated from the heating unit to a front of the heating unit.

4. A cooking apparatus, comprising:
a cabinet to provide an opening over which food to be cooked is laid;
a tray to removably move in and out of the cabinet through the opening and to be received in a cavity provided in an interior of the cabinet;
a grill unit seated in the opening of the cabinet to support the food over the opening;
a plurality of heating units installed in the cabinet to face the grill unit and to transmit thermal energy to the grill unit supporting the food laid thereon; and
a plurality of reflecting members provided at predetermined positions around the heating unit, the reflecting members installed to be spaced apart from each other by a predetermined gap to provide an air layer between the reflecting members.

5. The cooking apparatus according to claim 4, wherein the thermal heat generated by the heating units is repeatedly reflected by the reflecting members and limitedly transmitted to a portion of the heating units due to a heating insulating effect of the air layer provided between the reflecting members.

6. The cooking apparatus according to claim 4, wherein each of the heating units includes a ceramic member with a heating element to generate the thermal energy.

7. The cooking apparatus according to claim 4, wherein the heating units are respectively set in both sides of the cavity so that the front surface of the heating units are opposite to each other.

8. The cooking apparatus according to claim 4, wherein the heating units are inclinedly arranged to tilt toward the opening to transmit the thermal energy to the grill unit.

9. The cooking apparatus according to claim 4, wherein the grill unit comprises:
a plurality of water tanks seated on both sides of the cabinet to contain water; and
a plurality of grill pipes arranged between the water tanks to connect the water tanks to each other, and having hollow structures so that the water is supplied thereto from the water tanks and flows therein.

10. The cooking apparatus according to claim 9, wherein the grill pipes are continuously cooled by the water supplied by the water tanks, preventing the food supported by the grill pipes from being burnt.

11. The cooking apparatus according to claim 10, wherein the tray comprises:
a hump along a central axis thereof; and
reflecting plates provided at both sides of the hump, to reflect the thermal energy from the heating units to the grill unit.

12. The cooking apparatus according to claim 11, wherein the reflecting plates are respectively provided at predetermined positions below the grill unit to reflect the thermal energy of the heating unit to the grill unit, so that the thermal energy reflected by the heat blocking member is guided to a central portion of the grill unit by the reflecting plates.

13. The cooking apparatus according to 11, further comprising:
oil collecting grooves provided along an edge of the reflecting plates to collect oil dropping from the food which is laid on the grill unit.

14. The cooking apparatus according to claim 13, wherein a predetermined amount of water is contained in the tray to prevent an excessive rise in temperature of the oil collecting groove and the reflecting plates, preventing the oil collected in the oil collecting groove from being burnt and adhered to the tray.

15. The cooking apparatus according to claim 4, further comprising:
a timer switch to control an operation time of the heating units; and
a power switch to control a heating temperature of the heating units.

16. A cooking apparatus having a cabinet to provide an opening over which food to be cooked is laid and a tray to removably move in and out of the cabinet through the opening, the apparatus comprising:
a grill unit seated in the opening of the cabinet to support the food over the opening;
a plurality of heating units installed in the cabinet to face the grill unit and to transmit thermal energy to the grill unit supporting the food laid thereon; and
first, second, and third reflecting members provided at predetermined positions around the heating unit.
